(19) United States
(12) Patent Application Publication
(10) Pub. No.: US 2006/0251159 A1
(43) Pub. Date: Nov. 9, 2006

(54) Residential voice over broadband

(76) Inventors: Allen J. Huotari, Garden Grove, CA (US); Donald T. Mah, Trabuco Canyon, CA (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/091,030

(22) Filed: Mar. 28, 2005

(51) Int. Cl. H04L 5/16

(52) U.S. Cl. 375/222

(57) ABSTRACT

A method and system for facilitating voice over broadband communication for use in residences and small businesses is disclosed. A voice signal from an analog telephone is frequency upconverted. The frequency upconverted voice signal is communicated over pre-existing analog telephone wiring. The communicated frequency upconverted voice signal is then frequency downconverted for use by an integrated access device. In this manner, re-wiring of the residence or business is avoided.

### TECHNICAL FIELD

The present invention relates generally to network telephony. The present invention relates more particularly to a method and system for providing residential voice over a broadband network using pre-existing home telephone wiring.

### BACKGROUND

The use of voice over broadband for telephone communication is increasing in popularity as the technology matures and becomes more widely available. Voice over broadband is substantially less expensive when compared to traditional telephone systems. Voice over Internet Protocol (VoIP) is one example of voice over broadband.

In contemporary voice over broadband implementations, a plurality of telephones are plugged into an Integrated Services Device (IAD). Such configuration necessitates that wiring from each telephone directly to the IAD be provided. While direct wiring can generally be provided in business environments (where it can generally be easily strung through drop-down ceilings), it is more difficult to provide in residences and can be prohibitively expensive.

Residences typically have from one to three loops of category 3 wiring that extend throughout much of the home. Telephones tap into one (for single line telephones) or two (for two line telephones) of the loops via the use of RJ-11 connectors. However, the use of an IAD requires that each telephone be connect directly to the IAD, rather than be on a loop with other telephones. Thus, extensive re-wiring is generally required for the use of voice over broadband in residences according to contemporary practice.

Of course, such re-wiring of residences is undesirable because it is inconvenient and costly. Residences do not typically have drop-down ceilings. Re-wiring frequently requires that cable be laboriously pulled thought walls, attics, and/or crawl spaces.

As such, although the use of voice over broadband has proven generally suitable for business purposes, it possesses deficiencies which detract from its overall desirability in the home market. Therefore, it is desirable to provide a way to connect ordinary telephones to an IAD that does not require the rewiring of a home.

### BRIEF DESCRIPTION OF THE DRAWINGS

FIG. 1 is a block diagram showing the use of telephone adapters to provide connection of ordinary telephones to an Integrated Access Device (IAD) in a home, according to an exemplary embodiment of the present invention; and

FIG. 2 is a flow chart showing the processes of frequency upconverting and frequency downconverting used to facilitate the communication of voice signals via unmodified home telephone wiring according to an exemplary embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION OF THE PREFERRED EMBODIMENTS

The current model for Integrated Access Devices (IADs) is heavily business centric and thus assumes that telephones using a broadband derived voice line will be plugged directly into the IAD. However, as discussed above, this model is not practical for residential applications, since it tends to require extensive rewiring of a home's telephone system in order to accommodate such direct connection.

In order to overcome this deficiency associated with the contemporary use of IADs, one embodiment of the present invention facilitates the connection of one or more telephones to an IAD using standard, previously installed (typically twisted pair) home telephone wiring. That is, no new wires are needed. The system can operate in the plain old telephone system (POTS) mode as a default or failure mode to preserve lifeline 911 capability. The cost per node is low, particularly when compared with the cost of re-wiring a home to provide direct connection of each telephone with the IAD. The system does not require new telephones. That is, existing contemporary analog telephones are compatible with at least one embodiment of the present invention.

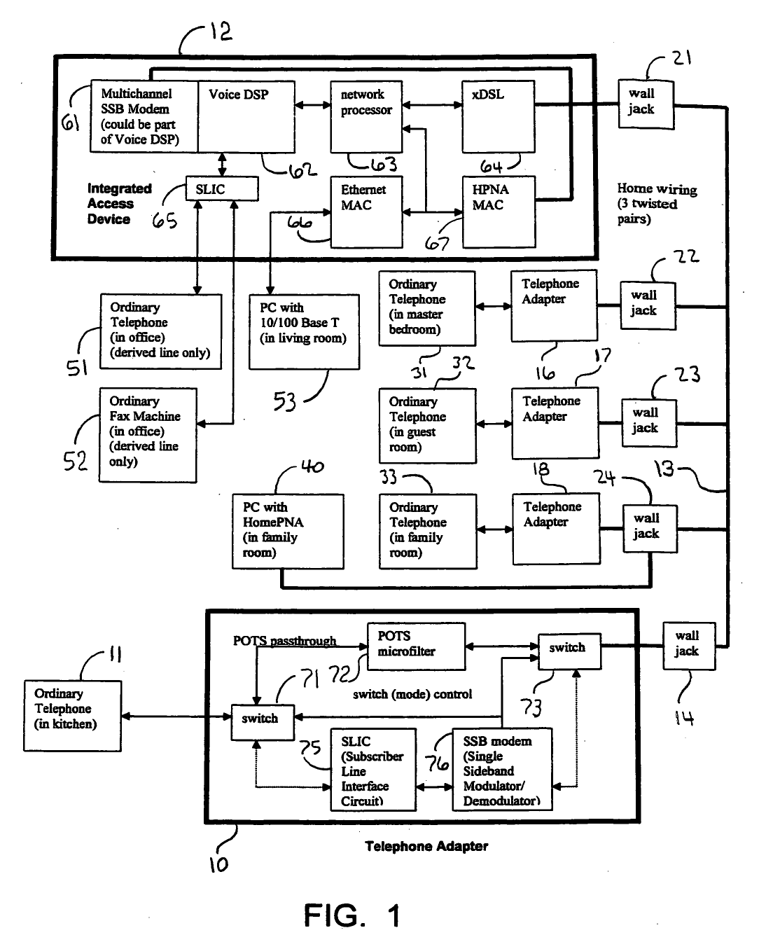

FIG. 1 shows a block diagram of an exemplary implementation of the use of telephone adapters to facilitate residential voice over broadband wherein existing home telephone wiring is used. A telephone adapter 10 facilitates communication between an ordinary analog telephone 11 in one room of a home (such as the kitchen) and an IAD 12 in another room (such as a home office) via pre-existing and unmodified home telephone wiring 13. Telephone adapter 10 is connected to home telephone wiring 13 via a wall jack 14.

In a similar manner, other telephone adapters 16, 17, and 18 facilitate communication between other telephones 31, 32, and 33 in other rooms of the home (such as in the master bedroom, guest room, and family room) and IAD 12. Telephone adapters 16, 17, and 18 are connected to home wiring 13 via wall jacks 22, 23, and 24, respectively.

In addition to telephone adapters 10, 16, 17, and 18, other devices may communicate via home wiring 13. For example, a personal computer (PC) 40 with a HomePNA network connection in one room (such as the family room) can be connected to home wiring 13 via wall jack 24 so as to facilitate communication with other computer equipment, such as PC 53 with a10/100 Base T Ethernet connection, which is in another room (such as in the living room).

Telephones that are physically proximate to IAD 12 can be connected directly thereto, without using home telephone wiring 13. Thus, ordinary analog telephone 51 (which may be located in a home office, for example) can be directly connected to IAD 12 via a derived line (a direct line to IAD 12). Similarly, other devices, such as ordinary fax machine 52 (which can also be located in the home office) can be connected directly to IAD 12 via a derived line.

Each telephone adapter 10 can comprise a first switch 71 that facilitates communication between the telephone 11 and the home telephone wiring 13 in either of two modes, i.e., the POTS mode and the single sideband (SSB) frequency division multiplexing (FDM) mode. First switch 71 thus routes telephone communications through optional POTS microfilter 72 or through SLIC 75 and SSB modem 76. POTS microfilter 72 can be a band pass or low pass filter that limits POTS communications substantially to the voice band, e.g. approximately 100 Hz to 4 KHz. The use of POTS microfilter 72 within adapter 10 mitigates the occurrence of drastic impedance discontinuity when switching. Furthermore, microfilter 72 provides isolation from potential noise generated by other equipment (e.g., HomePNA, xDSL, etc.) operating on home wiring 13.

SLIC 75 can be a contemporary subscriber line interface circuit that provides an interface between telephone 11 and SSB modem 76. SLIC 75 can optionally provide power to telephone 11. A second switch 73 similarly switches communications between telephone 11 and home telephone wiring 13. Both first switch 71 and second switch 73 are controlled by SSB modem 76, such that when SSB modem 76 is in use communications are routed therethrough and when SSB modem 76 is not in use communications are routed through POTS microfilter 72 to facilitate POTS passthrough.

IAD 12 can comprise a SLIC 65 which provides interface to analog devices such as telephone 51 and fax machine 52. SLIC interfaces such devices to a voice DSP 62 and can optionally provide power to such devices. Voice DSP 62 cooperates with multichannel SSB modem 61 to provide FDM communications via home telephone wiring 13.

Optionally, an Ethernet MAC 66 facilitates Ethernet communications, such as with PC 53. Ethernet MAC 66 cooperates with a Home Phone Network Alliance (HomePNA) medium access controller (MAC) and a network processor 63 to link Ethernet communications with HomePNA and analog communications according to well known principles. Indeed, IAD 12 can substantially be a contemporary device, with the addition of multichannel SSB modem 61, as long as voice DSP 62 is sufficiently powerful enough to handle the added burden of multichannel SSB modem 61.

An xDSL modem 64 facilitates broadband communications, typically via a wide area network (WAN) such as the Internet. Thus, telephones 11, 31, 32, and 33 can communicate via FDM with IAD 12 to accomplish broadband communications via the Internet.

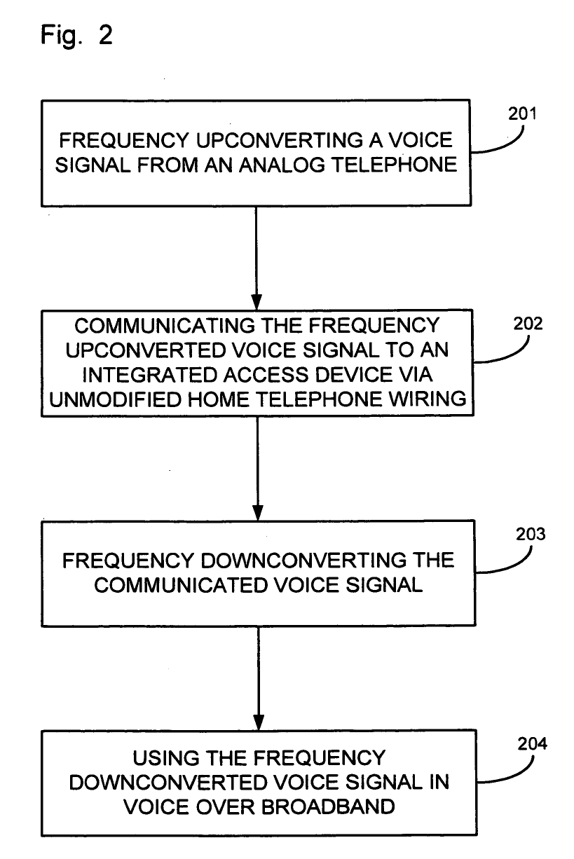

FIG. 2 is a flow chart that shows the processes of frequency upconverting and frequency downconverting used to facilitate the communication of voice signals via unmodified home telephone wiring according to an exemplary embodiment of the present invention. The voice signal from ordinary telephone 11 is upconverted, such as via telephone adapter 10, as indicated in block 201. The frequency upconverted voice signal is communicated to IAD 12 via unmodified, pre-existing home telephone wiring 13, as indicated in block 202. The frequency upconverted voice signal is downconverted, such as via multichannel SSB modem 61 of IAD 12, as indicated in block 203. The frequency downconverted voice signal is used in voice over broadband communication facilitated by xDSL 64 of IAD 12, as indicated in block 204.

According to one embodiment of the present invention, a plurality, such as four, voice lines can be accommodated via unmodified home telephone wiring 13. However, as those skilled in the art will appreciate, other numbers of voice lines, such as six, eight, or twelve voice lines, can alternatively be accommodated.

According to one aspect, the present invention does not interfere with discrete multi-tone (DMT) based digital subscriber lines (xDSLs) or HomePNA products and is not substantially susceptible to interference from such product, even when operating on the same wire pair as DMT based xDSLs or HomePNA products.

According to one aspect, the present invention is compatible with (and can also be independent and agnostic with respect to) existing voice over broadband standards, and is likely to be compatible with future proposals for voice over broadband. According to one aspect, standard voice features are preserved. Thus, dialing (call origination/initiation) and ringing (call termination/answering) are preserved. Non-standard voice features can also be preserved. That is, features such as call waiting, caller ID (including distinctive/priority ringing), call forwarding, call screening, auto dialing, and conferencing can be preserved.

According to one aspect of the present invention, an adapter can be provided between the wall RJ-11 jack and the legacy telephone. The adapter can be powered by line AC. Alternatively, the adapter can be powered by the telephone line itself. The adapter can optionally have a battery backup.

A typical contemporary IAD in effect provides a local loop to the telephone, i.e., the subscriber line interface circuit (SLIC) in the IAD powers the telephone. The present invention deviates from that model since the home wiring must be shared between POTS and digital voice. Thus, the adapter itself (rather than the IAD) can provide loop voltage to the telephone when it is operating in the digital mode. That is, the adapter can comprise a SLIC. Therefore the adapter can be configured to switch between the normal mode of POTS pass through to directly providing loop voltage to the telephone when in digital mode. However, since the POTS local loop and the IAD derived local loop should not co-exist simultaneously on the same twisted pair, sufficient (redundant) isolation can be provided when switching between POTS and digital modes.

According to one embodiment of the present invention, the adapter operates in POTS mode, i.e., provides POTS pass through, until a digital mode is invoked for the use of voice over broadband. In the event of a power failure, the adapter can be configured to operate only in POTS pass through mode to preserve lifeline 911 capability. In a digital mode, the adapter can switch the telephone away from POTS to the method of the present invention.

The mechanism for switching between POTS and digital mode can be either a manual switch (user initiated actuation), or could be done automatically. For example, when the attached telephone goes off hook, the adapter can check for POTS dial tone. If there is no dial tone, then the adapter can switch automatically to digital mode. This is a caller prefers POTS model. A caller prefers digital voice model can similarly be implemented.

The above description provides a means by which a legacy telephone can be switched between a common home POTS mode and a local digital mode, with isolation between these modes. Next is a discussion of how voice traffic can be communicated from a contemporary analog telephone to the IAD in a manner that does not disturb or otherwise conflict with POTS, xDSL, or HomePNA.

A substantial amount of the energy content of the human voice is concentrated in the frequency range of 100 Hz to 4 kHz. For simplicity, assume that voice occupies approximately a 4 kHz bandwidth. However, note that the use of a 4 kHz bandwidth herein is by way of example only, and not by way of limitation. Various other bandwidths can similarly be used according to the present invention. Analog voice for POTS generally requires a 4 kHz bandwidth channel between approximately 0 Hz (DC) and approximately 4 kHz. Moreover, any analog voice channel generally requires approximately 4 kHz of bandwidth no matter where it is spectrally located.

According to one embodiment of the present invention, the connection of a plurality of analog telephones to one IAD is facilitated. The resulting use of four derived voice channels necessitates that at least 16 kHz (4 kHz for each analog telephone) be allocated on the twisted pair. In order to provide dedicated transmit and receive channels for each telephone, 32 kHz can be provided. Additional bandwidth may be allocated to provide for guard bands between channels. This bandwidth can be allocated somewhere above POTS and where it is compatible with DMT based xDSLs and HomePNA. This bandwidth does not require contiguity, although in some instances it may be desirable to provide contiguity.

The adapter can optionally digitize the voice signal between the telephone and the IAD. However, it is generally not desirable to do so. To be properly digitized, an analog voice signal should be sampled at 8 kHz with 8 bits of quantization. This yields a serial data rate of 64 kbps (assuming no framing bits). However, 64 kbps is approximately the limit of contemporary voice switching gear and is the basis of an integrated services digital network (ISDN) basic rate interface (BRI) channel. Despite the simplicity of such circuitry, the bandwidth of a single 64 kbps binary stream is undesirably high, i.e., it is twice that of all 4 channels in analog mode.

Even assuming that 8 bit pulse code modulation (PCM) samples at 8 kHz are sent across the twisted pair (as discrete voltage levels), the fact that this is a pulse modulated scheme implies harmonic spurs at multiples of the sampling (pulse) rate. Such harmonic spurs would very likely be detrimental to xDSL and HomePNA. Further, such methodology is simply not an efficient use of bandwidth, even if it is a vast improvement over the binary serial method.

Optionally, a more spectrally efficient digital modulation scheme, such as one of those commonly used for digital cellular telephony, could be used. However, it is important to appreciate that the use of such modulation can substantially increase the cost of the adapter.

Therefore, according to one embodiment of the present invention, analog voice is preserved and an analog modulation scheme is used to communicate voice between the adapter and the IAD. The transmission of analog voice is a bandwidth efficient method and is comparatively inexpensive to implement.

It is worthwhile to note that the communication of analog voice between the adapter and the IAD does not prohibit or even limit the use of digital control or implementation of the analog voice signal. Indeed, the voice signal can optionally be digitally controlled or otherwise digitally implemented.

Thus, according to one aspect of the present invention, narrowband analog voice signals are channelized in a manner similar to that of traditional frequency division multiplexing (FDM). Such traditional FDM that has previously been used in single sideband (SSB) modulation to up and down convert analog voice channels into 4 kHz wide frequency bins so as to provide a multiplexed aggregation of voice traffic onto twisted pair or coax. In this manner, 25 analog voice calls occupy 100 kHz of spectrum. Although the analog based FDM methodology has been all but replaced by the digital based time division multiplexing (TDM) methodology (such as T1 and T3 in North America, as well as E1 and E3 in Europe) and optical based methodologies (OC-n), analog FDM principles still apply today, especially in RF technologies like cellular telephony, and radio/television broadcasting.

The present invention mitigates adding further cost to the IAD. The use of FDM, according to one aspect of the present invention, does require a multichannel receiver/transmitter in the IAD to multiplex/demultiplex voice traffic from each derived line. However, the multichannel receiver/transmitter can be implemented within a digital signal processor (DSP). For example, the receiver can be a multirate polyphase filter and the transmitter can be a multichannel SSB transmitter based upon Hilbert transformations. Thus, the transmitter and the receiver can be implemented within the same DSP (as long as the DSP is sufficiently powered) as that used for the voice codecs in the IAD.

According to one aspect of the present invention, voice traffic is converted from it's base 0-4 kHz bandwidth to a 4 kHz bandwidth centered at some higher carrier frequency. The higher frequency can be programmable (such as via user assignment or an automated method). These frequencies can be allocated so that they do not interfere with xDSL or HomePNA and visa-versa. Control signals, such as those used to ring a telephone, can either be in-band or out-of-band, as desired.

The transmit and receive voice can use separate channels. In this instance, the transmit and receive channels can be associated to one another and thus not be individually programmable.

On the network side, in the digital mode adapter 10 will essentially appear to be a modem to the network, i.e., it can be configured to present the same impedance characteristics as any telephony device. The impedance discontinuity when switching from POTS to digital and vice versa can be fully characterized and understood. Thus, any impact to fast retrain can be minimal.

Optionally, SLIC 65 can be removed from IAD 12 and provided instead in each adapter 10, 16, 17, and 18. The signal provided to the RJ-11 jack (and the xDSL front end) can be routed to the DSP implementing the IAD voice functions with very little or no additional circuitry.

The cost of implementing the present invention is mostly in the SSB modem 76, a power supply (not shown), and an enclosure for the telephone adapter 10. The cost of the adapter itself must be weighed against the cost of rewiring the residence. It is important to appreciate that ultimately, it's not the cost of goods alone, but rather the cost of deploying those goods, that contributes the most to overall costs.

The compatibility of the present invention with other devices such as ADSL, VDSL, and HomePNA is discussed below. POTS occupies 0 Hz to 4 KHz and provides an unoccupied region from 8.625 KHz to 21.5625 kHz for DMT tones 2-5 (4 tones in all).

For DMT asymmetric digital subscriber line (ADSL) and HomePNA the allocated frequencies are: G.992.1 and G.992.2 and G.992.3 and G.992.5 ATU-R upstream is from 25.875 KHz to 138 kHz (DMT tones 6-32); G.992.1 and G.992.3 ATU-R downstream is from 142.3125 KHz to 1104 kHz (DMT tones 33-256); G.992.2 ATU-R downstream is from 142.3125 kHz to 512 kHz (DMT tones 33-128); G.992.5 ATU-R downstream is from 142.3125 kHz to 2208 kHz (DMT tones 33-512); G.992.2 is unoccupied from 516.3125 kHz to 1104 kHz (DMT tones 129-256, 128 tones in all); Between G992.1 and HomePNA is unoccupied from 1.104 MHz to 5.5 MHz, but can have interference from amateur radio; between G992.5 and HomePNA is unoccupied from 2.208 MHz to 5.5 MHz, but can have interference from amateur radio; and HomePNA from 5.5 MHz to 9.5 MHz.

The allocated frequencies for VDSL include an unoccupied region from 8.625 kHz to 133.6875 kHz (DMT tones 2-31, i.e., 30 tones in all) and several different plans as discussed below. For VDSL Plan 997 (ETSI, ITU-T), the frequency allocations are: VDSL 1^{st} downstream 138 kHz to 3.00 MHz; VDSL 1^{st} upstream 3.00 MHz to 5.1 MHz; VDSL 2^{nd} downstream 5.1 MHz to 10 7.05 MHz; and VDSL 2^{nd} upstream 7.05 MHz to 12 MHz.

For VDSL Plan 998 (ETSI, ANSI, ITU-T), the frequency allocations are: VDSL 1^{st} downstream 138 kHz to 3.75 MHz; VDSL 1^{st} upstream 3.75 MHz to 5.2 MHz; VDSL 2^{nd} downstream 5.2 MHz to 8.5 MHz; and VDSL 2^{nd} upstream 8.5 MHz to 12 MHz.

For VDSL Flexible Plan Fx (ITU-T) VDSL 1^{st} downstream 138 kHz to 2.5 MHz; VDSL 1^{st} upstream 2.5 MHz to 3.75 MHz; VDSL 2^{nd} downstream 3.75 MHz to Fx MHz (Fx=6 or 10.125 MHz); and VDSL 2^{nd} upstream Fx MHz to 12 MHz (Fx=6 or 10.125 MHz).

For the Chinese Plan VDSL 1^{st} downstream is from 138 kHz to 3.75 MHz; VDSL 1^{st} upstream is from 3.75 MHz to 8.5 MHz; and VDSL 2^{nd} downstream is from 8.5 MHz to 12 MHz.

The internationally recognized amateur radio bands are from 1.800 MHz to 2.000 MHz; from 3.500 MHz to 4.000 MHz; from 7.000 MHz to 7.300 MHz; from 10.100 MHz to 10.150 MHz; from 14.000 MHz to 14.350 MHz; from 18.068 MHz to 18.168 MHz; from 21.000 MHz to 21.450 MHz; from 24.890 MHz to 24.990 MHz; and from 28.000 MHz to 29.100 MHz.

Thus, for residential G.992.2 deployment, at least one embodiment of the present invention can use the unoccupied region from 516.3125 kHz to 1104 kHz (128 channels of 4.3125 kHz each). However, some compensation for AM radio interference may be needed. For residential VDSL deployment, one embodiment of the present invention can use the unoccupied region from 8.625 kHz to 133.6875 kHz (30 channels of 4.3125 kHz each). For residential G.992.1/G.992.3 deployment, one embodiment of present invention can begin to use bins as necessary from 1104 kHz downwards (i.e., use bins that are most likely to be unusable by ADSL/ADSL2). For residential G.992.5 deployment, then one embodiment of present invention can begin to use bins as necessary from 2208 kHz downwards (i.e., use bins that are most likely to be unusable by ADSL2+). For residential cable modem (DOCSIS) deployment, the present invention can use any of the unoccupied home wiring bandwidth, since xDSL is not used. For terrestrial wireless or satellite based deployment, the one embodiment of the present invention can use any of the unoccupied home wiring bandwidth, since xDSL is not used. The present invention can use 2 tones/voice channel (i.e., one for upstream and one for downstream).

More particularly, according to one embodiment of the present invention, frequencies from the unoccupied range of 8.625 kHz to 21.5625 kHz range (DMT tones 2-5, i.e., 4 tones in all) can be used for transmission/reception of voice on residential wiring. According to one embodiment of the present invention, frequencies from the unoccupied region of 516.3125 kHz-1104 kHz range (for G.992.2, DMT tones 129-256, 128 tones in all) can be used for transmission/reception of voice on residential wiring. According to one embodiment of the present invention, frequencies from the unoccupied region of 1.104 MHz to 5.5 MHz range (between G.992.1/G.992.3 and HomePNA) can be used for transmission/reception of voice on residential wiring. According to one embodiment of the present invention, frequencies from the unoccupied region of 2.208 MHz to 5.5 MHz range (between G.992.5 and HomePNA) can be used for transmission/reception of voice on residential wiring. According to one embodiment of the present invention, frequencies from the unoccupied region from 8.625 kHz to 133.6875 kHz range (for North Am VDSL, DMT tones 2-31, i.e., 30 tones in all) can be used for transmission/reception of voice on residential wiring. According to one embodiment of the present invention, frequencies above 9.5 MHz can be used for transmission/reception of voice on residential wiring.

Further, unused downstream subcarrier frequencies (aka tones or bins) can be used for transmission/reception of voice on residential wiring and unused upstream subcarrier frequencies (aka tones or bins) can be used for transmission/reception of voice on residential wiring.

Further, all of the appropriate frequencies on the third pair (common in home wiring) can be used, if the third pair is available. All of the appropriate frequencies on any pair can be used, if non-xDSL technology is employed for residential broadband (e.g., if cable modem or satellite is used instead of xDSL).

Unused downstream subcarrier frequencies can be forced during C-MEDLEY (which sets the transmission speed and bit number for transmissions that are to be placed upon a carrier) through programming at the ADSL Termination Unit—Central (ATU-C) for the purpose of reserving the resultant unused frequencies for transmission/reception of voice on residential wiring. Unused downstream subcarrier frequencies can be forced during R-B&G through programming of bi and gi at the ADSL Termination Unit—Remote (ATU-R) for the purpose of reserving the resultant unused frequencies for transmission/reception of voice on residential wiring. Unused upstream subcarrier frequencies can be forced during R-MEDLEY through programming at ATU-R for the purpose of reserving the resultant unused frequencies for transmission/reception of voice on residential wiring. Unused upstream subcarrier frequencies can be forced during C-B&G through programming of bi and gi at ATU-C for the purpose of reserving the resultant unused frequencies for transmission/reception of voice on residential wiring. Unused downstream subcarrier frequencies can be forced through filtering at either ATU-C or ATU-R for the purpose of reserving the resultant unused frequencies for transmission/reception of voice on residential wiring. Unused upstream subcarrier frequencies can be forced through filtering at either ATU-C or ATU-R for the purpose of reserving the resultant unused frequencies for transmission/reception of voice on residential wiring.

Single side band modulation/demodulation can be used for any of the above frequency ranges. Similarly, frequency division multiplexing can be used for any of the above frequency ranges.

Any of the above methods can be used for the transmission/reception of in band voice signaling on residential wiring. Any of the above methods can be used for the transmission/reception of out of band voice signaling on residential wiring.

An adapter between a conventional telephone and an IAD (or gateway) can thus be used for the purpose of converting the telephone from a POTS device to one used on a derived digital line. The use of such an adapter can allow a conventional telephone to switch (either automatically or manually) from a POTS device to one used on a derived digital line. The use of an adapter can facilitate the up conversion and downconversion (both of which are forms of modulation) of conventional analog POTS voice to and from a higher frequency (which function as a carrier) for transmission/reception on residential wiring. The adapter can allow the selection of the carrier to be automatically or manually performed or modified. Separate carriers can be used for transmit voice and receive voice for each derived voice line.

A microfilter or splifter can be embedded within the adapter for the purpose of impedance matching or minimizing discontinuity when the adapter switches between POTS and derived digital line. Redundant switching and isolation elements can be used to provide enhanced safety of the telephone network in the event of adapter failure.

The present invention can use upstream ADSL tones. However, there may be some adverse impact on upstream communications, which are more sensitive that downstream communications. Unused tones can be used to control the peak-to-average ratio (PAR) via destructive interference. Locally, the upstream will be used for this function.

Although the system for residential voice over broadband is describe herein as being used in residential applications, such use is by way of example only, and not by way of limitation. One or more aspects of the present invention are suitable for use in offices or other environments.

Thus, according to the present invention, voice over broadband is facilitated in residential and similar environments without requiring that telephone wiring be redone so as to provide direct connection to an IAD. Thus, the cost associated with the implementation of voice over broadband in such implementation is substantially reduced.

Embodiments described above illustrate, but do not limit, the invention. It should also be understood that numerous modifications and variations are possible in accordance with the principles of the present invention. Accordingly, the scope of the invention is defined only by the following claims.

1. An adapter for facilitating use of an analog telephone in voice over broadband communication, the adapter comprising:
a circuit for processing a POTS signal;
a modulator/demodulator circuit; and
a switching circuit configured to route communications between a telephone and home wiring through a selected one of the circuit for processing a POTS signal and the modulator/demodulator circuit.

2. The adapter as recited in claim 1, wherein the circuit for processing a POTS signal comprises a POTS microfilter.

3. The adapter as recited in claim 1, wherein the modulator/demodulator circuit comprises a single sideband modem.

4. The adapter as recited in claim 1, wherein the switching circuit comprises a first switch to which a telephone is connectable and a second switch to which home telephone wiring is connectable.

5. A method for facilitating use of an analog telephone in voice over broadband communication, the method comprising operating a switch so as to effect one of:
processing a POTS signal for communication between a telephone and home wiring; and
modulating/demodulating a signal for communication between a telephone and home wiring.

6. The method as recited in claim 5, wherein modulating/demodulating a signal comprises frequency up conversion of communications from the telephone to home wiring and frequency down conversion of communications from home wiring to the telephone.

7. The method as recited in claim 5, wherein processing a POTS signal comprises microfiltering the POTS signal.

8. The method as recited in claim 5, wherein modulating/demodulating a signal comprises single sideband modulating/demodulating the signal.

9. The method as recited in claim 5, wherein modulating/demodulating a signal comprises modulating/demodulating a signal having a bandwidth of approximately 4 kHz.

10. The method as recited in claim 5, wherein modulating/demodulating a signal comprises modulating/demodulating a signal for a frequency band selected from the group consisting of:
516.3125 kHz to 1104 kHz;
8.625 kHz to 133.6875 kHz;
bins from 1104 kHz downward, as needed; and
2208 kHz. To 5500 kHz.

11. An adapter for facilitating use of an analog telephone in voice over broadband communication, the adapter comprising:
means for facilitating POTS passthrough;
means for modulating and demodulating a signal; and
a switching circuit configure to route communications between a telephone and home wiring through a selected one of the means for facilitating POTS passthrough and the means for modulating and demodulator a signal.

12. An integrated access device comprising:
a multichannel FDM modem;
a digital signal processor; and
wherein the multichannel FDM modem cooperates with the digital signal processor to facilitate the use of an analog telephone in broadband communications using pre-existing home telephone wiring.

13. The integrated access device as recited in claim 12, wherein the multichannel FDM modem comprises a multichannel single sideband modem.

14. The integrated access device as recited in claim 12, wherein the multichannel FDM modem comprises a multichannel single sideband modem that is configured to modulate/demodulate a signal having a bandwidth of approximately 4 kHz

15. The integrated access device as recited in claim 12, wherein the multichannel FDM modem comprises a multichannel single sideband modem that is configured to modulate/demodulate a signal in a frequency band selected from the group consisting of:
516.3125 kHz to 1104 kHz;
8.625 kHz to 133.6875 kHz;
bins from 1104 kHz downward, as needed; and
2208 kHz. To 5500 kHz.

16. The integrated access device as recited in claim 12, further comprising at least one of a xDSL modem or cable modem for facilitating broadband communications.

17. A method for facilitating use of analog telephones in voice over broadband communication, the method comprising multichannel frequency division multiplexing a plurality of signals to facilitate operation of the analog telephones using pre-existing home telephone wiring.

18. The method as recited in claim 17, wherein multichannel frequency division multiplexing comprises modulating/demodulating a signal having a bandwidth of approximately 4 kHz.

19. The method as recited in claim 17, wherein multichannel frequency division multiplexing comprises modulating/demodulating a signal in a frequency band selected from the group consisting of:
516.3125 kHz to 1104 kHz;
8.625 kHz to 133.6875 kHz;
bins from 1104 kHz downward, as needed; and
2208 kHz. To 5500 kHz.

20. The method as recited in claim 17, further comprising using at least one of a xDSL or cable modem to provide broadband communication.

21. An integrated access device comprising:
means for frequency division modulating a signal;
means for digitally processing a signal; and
wherein the means for frequency division modulating a signal and the means for digitally processing a signal cooperate to facilitate the use of an analog telephone in broadband communications using pre-existing home telephone wiring.
